(19) United States
(12) Patent Application Publication
(10) Pub. No.: US 2007/0019833 A1
(43) Pub. Date: Jan. 25, 2007

(54) Hearing device and method for setting an amplification characteristic

(75) Inventor: Roland Barthel, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 11/492,433

(22) Filed: Jul. 25, 2006

(30) Foreign Application Priority Data
Jul. 25, 2005 (DE) 10 2005 034 647.2

(51) Int. Cl. H04R 25/00

(52) U.S. Cl. 381/320

(57) ABSTRACT

The amplification of a hearing device, in particular a hearing aid, is to be improved for different useful signal level ranges. Provision is made to this end for the hearing device first to determine the useful signal level range and then to displace a knee point of the amplification characteristic as a function of the useful signal level range. The knee point is favorably displaced below the useful signal level range. The useful signal level range is thus amplified in a linear manner and audible distortions do not occur.

### CROSS REFERENCE TO RELATED APPLICATIONS

This application claims priority of German application No. 10 2005 034 647.2 filed Jul. 25, 2005, which is incorporated by reference herein in its entirety.

### FIELD OF THE INVENTION

The present invention relates to a method for setting an amplification characteristic of a hearing device, in particular a hearing aid, with the amplification characteristic, which defines the amplification between input and output signal levels, comprising a first essentially linear characteristic range, a second essentially linear characteristic range and a knee point lying therebetween. Furthermore, the present invention relates to a hearing device with a corresponding amplification facility.

### BACKGROUND OF THE INVENTION

The phenomenon of recruitment, i.e. a pathological increase in loudness, often occurs in the case of people suffering from inner ear hearing impairment. This can be explained as follows: in the case of people with normal hearing, the extensive dynamic range of naturally occurring acoustic signal levels is compressed into a relatively small range of excursions on the basilar membrane by the function of the outer hair cells and the active processes. If this process fails, the excursions for small input signal levels lie below the perception limit, whilst with average input levels the perception limit is exceeded and the overall perception range is covered from average levels up to high levels. This results in a significant increase in the subjective loudness function.

To compensate for recruitment in hearing impaired people and to improve speech intelligibility, input signals are compressed with digital hearing systems, i.e. quiet signals are amplified more significantly than loud signals. It is however known that hearing aid wearers often prefer linear settings, because the sound is perceived as more pleasant. Efforts are thus continuously made to design the amplifier such that a linear amplification takes place in the useful signal level range. To this end, it is necessary to separate the amplification characteristic, i.e. the transmission function from input signal to output signal level into two linear ranges L1 and L2, which are separated by a knee point K, as shown in FIG. 1. This curve pattern clearly shows that lower input signal levels are amplified more significantly and higher input signal levels above the knee point K1 are amplified less significantly. A compression thus results in the linear range L2. FIG. 1 shows a useful and/or input signal level range EB, in which most voice signals typically lie. In the selected example the input signal level range is from 50 dB to 80 dB.

As the knee point K1 lies in the level range EB of the useful signal, distortions can be audible in some circumstances. Therefore the amplification of a hearing aid is set in the known manner using hardware or software, such that the knee point K1 of the amplification lies below the useful signal level range EB, as shown in FIG. 2. In this instance the amplification of the signal is indeed lower and the signal is compressed but the hearing aid wearer finds this more acceptable than interfering distortions. The hearing aid thus behaves in a linear manner and harmonics that occur due to a non-linear characteristic when the useful signal level fluctuates about the knee point are no longer to be feared. A more natural hearing sensation thus results with a voice or music type useful signal.

Alternatively the knee point of the amplification curve can also lie above the useful signal level range EB. This is however rather unfavorable as the required recruitment compensation is difficult to achieve.

The setting of the knee point is however based on assumptions which are made during adjustment of the hearing system. If the level range of the useful signal changes, the adjustment is no longer ideal. If the adjustment was carried out for instance for a quiet speaker, problems result during a subsequent communication with a loud speaker as the useful signal level range is displaced upward here. Problems can likewise also occur with music with a high dynamic, as the level range there is very wide.

### SUMMARY OF THE INVENTION

The object of the present invention is therefore to optimize the amplification of a hearing device, such that fewer distortions occur due to the non-linearity of the amplification characteristic with different useful signal level ranges.

According to the invention, this object is achieved by a method for setting an amplification characteristic of a hearing device, in particular a hearing aid, with the amplification characteristic, which defines the amplification between input and output signal levels, comprising a first essentially linear characteristic range, a second essentially linear characteristic range and a knee point lying therebetween, by acquiring an input signal level range and displacing the knee point as a function of the input level range.

Furthermore a hearing device, in particular a hearing aid, is provided according to the invention, with an amplification facility, the amplification characteristic of which defines the amplification between the input and output signal levels and comprises a first essentially linear characteristic range, a second essentially characteristic range and a knee point lying therebetween, with an acquisition facility to acquire an input signal level range and an adaptation facility to displace the knee point of the amplification facility as a function of the input signal level range.

The required sound quality can always be achieved by the inventive, automatic adjustment of the amplification characteristic to the useful and/or input signal level range.

The knee point of the amplification characteristic is preferably displaced below the input signal level range. Optimum loudness and linear amplification can then always be provided in the useful and/or input signal level range. No distortions and a pleasant sound subsequently result in the relevant range.

Furthermore the amplification characteristic can comprise a second knee point, which lies between the second essentially linear characteristic range and a third essentially characteristic range, with the second knee point lying or being positioned above the input signal level range. The compression can thus be better controlled in the upper level range and the useful level signal range experiences a linear amplification as before.

### BRIEF DESCRIPTION OF THE DRAWINGS

The present invention is described in more detail based on the attached drawings, in which:

FIG. 1 shows a level range of a useful signal about a knee point;

FIG. 2 shows a knee point of the amplification characteristic below the useful signal range and

FIG. 3 shows an amplification characteristic with two knee points lying below and above the useful signal range.

### DETAILED DESCRIPTION OF THE INVENTION

The exemplary embodiments described below in further detail represent preferred embodiments of the present invention.

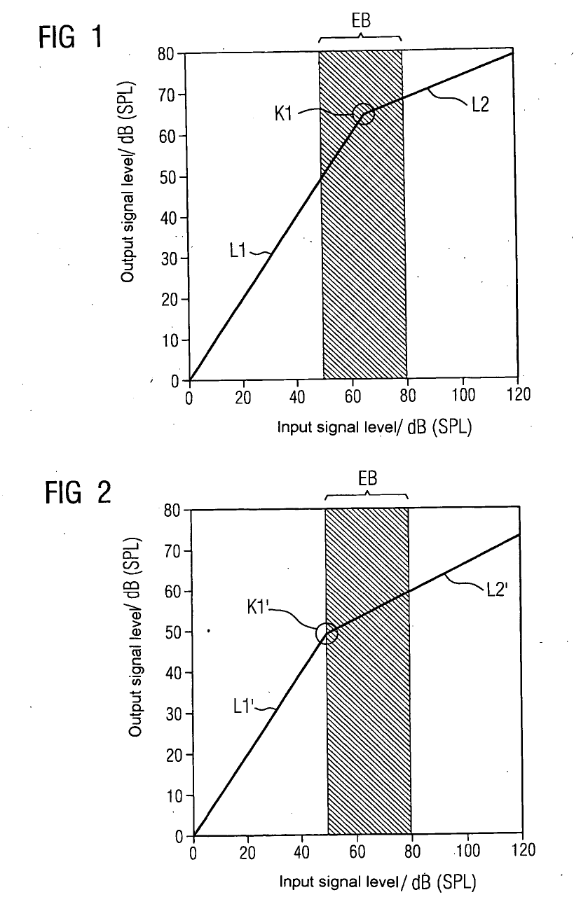

According to the invention, the level range of the useful signal is first determined in order to set the amplification characteristic. To this end a level estimator is provided for instance in the inventive hearing device and/or hearing aid. It determines the useful and/or input signal level range EB. In the example in FIG. 1, this range lies between 50 dB and 80 dB, as mentioned in the introduction. In the example selected here, the amplification characteristic features the pattern already described above, with two linear segments L1 and L2 as well as a knee point K1 lying therebetween.

After the input signal level range EB has been automatically determined, the knee point is slowly corrected in an adaptive manner in respect of the lower end of the useful signal level range EB. A new knee point K1 ′ ultimately results at the point indicated in FIG. 2. It now separates the linear ranges L1′ and L2′.

Correction takes place in the present example such that the rise of the amplification characteristic is retained in the linear range L1 up to the useful signal level range EB. In the useful signal level range and beyond, the rise and/or compression of the original linear range L2 is selected such that the new linear range L2′ results.

Alternatively correction of the knee point could also be carried out by varying the rise of the linear ranges and predetermining the end points of the linear ranges. The knee point could for instance always be set at the output signal level 50 dB at the start of the useful signal level range EB.

The amplification of the useful signal is indeed smaller after correction of the knee point and the useful signal is more compressed but no distortions occur due to non-linearities.

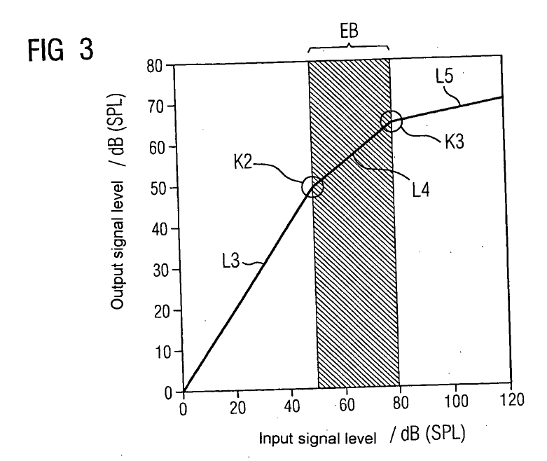

With another embodiment of the present invention, the amplification characteristic of the hearing device according to FIG. 3 features two knee points K2 and K3. These two knee points K2 and K3 separate the linear ranges L3, L4 and L5 from one another. The amplification characteristic is also adjusted automatically here to the useful and/or input signal level range EB. This means that the knee point K2 is automatically displaced below the useful signal range EB or to its lower edge and the second knee point K3 is automatically displaced above the useful signal range EB or to its upper edge. In the case of the example selected, the overall output signal level range is then smaller than in the case of the examples illustrated above with one knee point but the overall amplification can then be increased and the useful signal can thus be played back louder. The signals above the second knee point K3 are significantly compressed but they are not of major importance since they lie outside the essential input signal level range. One advantage of this amplification variant is that the output amplification range can be significantly reduced in practice without any loss of quality for the user.

1-6. (canceled)

7. A method for setting an amplification characteristic which defines the amplification between an input and output signal levels of a hearing device, comprising:
setting a first linear characteristic range of the hearing device;
setting a second linear characteristic range the hearing device;
setting a transition point between the first and second linear characteristic ranges;
acquiring an input signal level range of the hearing device; and
displacing the transition point as a function of the input level range.

8. The method as claimed in claim 7, wherein the transition point is displaced below the input signal level range.

9. The method as claimed in claim 7, wherein the amplification characteristic comprises a second transition point which is located between the second linear characteristic range and a third linear characteristic range.

10. The method as claimed in claim 9, wherein the second transition point is displaced as a function of the input signal level range and above the input signal level range.

11. The method as claimed in claim 7, wherein the hearing device is a hearing aid.

12. The method as claimed in claim 7, wherein the transition point is a keen point.

13. A hearing device, comprising:
an amplification unit for defining an amplification characteristic between an input and output signal levels of the hearing device, the amplification characteristic comprising:
a first linear characteristic range,
a second linear characteristic range, and
a transition point located between the first and second linear characteristic ranges;
an acquisition unit for acquiring an input signal level range; and
an adaptation unit for displacing the transition point as a function of the input signal level range.

14. The hearing device as claimed in claim 13, wherein the transition point is displaced at a lower edge of the input signal level range.

15. The hearing device as claimed in claim 13, wherein the amplification characteristic comprises a second transition point which is located between the second linear characteristic range and a third linear characteristic range.

16. The hearing device as claimed in claim 15, wherein the second transition point is displaced as a function of the input signal level range and at an upper edge of the input signal level range.

17. The hearing device as claimed in claim 13, wherein the hearing device is a hearing aid.

18. A hearing device, comprising:
an amplification unit for defining an amplification characteristic between an input and output signal levels of the hearing device, the amplification characteristic comprising:
a first linear characteristic range,
a second linear characteristic range,
a third linear characteristic range,
a first transition point located between the first and second linear characteristic ranges, and
a second transition point located between the second and third linear characteristic ranges;
an acquisition unit for acquiring an input signal level range; and
an adaptation unit for moving the first and second transition points as a function of the input signal level range.

19. The hearing device as claimed in claim 18, wherein the first transition point is moved at a lower edge of the input signal level range and the second transition point is moved at an upper edge of the input signal level range.
